(19) United States
(12) Patent Application Publication
(10) Pub. No.: US 2016/0160494 A1
(43) Pub. Date: Jun. 9, 2016

(54) METHOD OF PROTECTING A WOODEN STRUCTURE

(71) Applicant: David Allen Turner, Arlington, TX (US)

(72) Inventor: David Allen Turner, Arlington, TX (US)

(21) Appl. No.: 14/561,208

(22) Filed: Dec. 4, 2014

(51) Int. Cl. E04B 1/64; B05D 7/06; E04B 1/26

(52) U.S. Cl. CPC E04B 1/64; E04B 1/26; B05D 7/06; B05D 2203/20; B05D 2530/00

(57) ABSTRACT

A method is disclosed for the application of a coating for protection of a wooden structure. The method includes the steps of grinding used tired into a crumb followed by making a slurry from the crumb containing one or more additives or agents. The slurry is applied in a single coating to the wooden structure and permitted to dry. The coating encloses the wooden structure and is configured to act as a barrier to natural elements to prevent rot and insect damage.

### BACKGROUND

1. Field of the Invention

The present application relates generally to wooden structures and, more particularly, to a method of protecting wooden structures with a flexible and recycled product.

2. Description of Related Art

Wood has been a core building material for ages. Wood is typically strong and durable but can be susceptible to rot, disease, decay, and insects. Many efforts have been made to make wood more resistive to these problems. Methods such as soaking the wood in a pressurized chemical bath to press treating chemicals into the wood has been tried and used. Other processes are used to coat the wood. Such wood coatings require multiple steps and are laborious. For example, various grades of material are to be layered in sequential steps, each requiring sufficient dry time. Additionally, these are generally applied at the final location of the wooden structure. Furthermore, the act of coloring or staining of the wooden structure to a color of choice requires yet an additional step.

Additionally, approximately 259 million tires are used annually in the United States. Almost half are burned for fuel, releasing harmful bi-products into the air as pollution. A new way to recycle tires is needed.

It is desirable to provide an improved method and protecting wooden structures that is more efficient, more durable, and more resistant to cracking all while improving the environment. Although some advancements have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a side view of an exterior coating applied to a wooden fence structure according to the preferred embodiment of the present application;

FIG. 2 is a side view of an alternative embodiment of the wooden fence structure of FIG. 1 sealed by the exterior coating;

FIG. 3 is a section view of the wooden fence structure of FIG. 2 showing the use of seals in communication with a fastener;

FIG. 4 is a chart of the process for coating and protecting a wooden structure as applied in FIGS. 1-3; and

FIG. 5 is a chart of steps used to make a slurry in the process of FIG. 4.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The method of protecting a wooden structure as described in the present application involves the steps of generating a particular slurry from the ground up remnants of used tires and enclosing the wooden structure within a single coating of the slurry. The wooden structure is not limited to any particular shape, size, or type of structure. In the preferred embodiment it is understood that the wooden structure is a wooden fence including at least one of the pickets, cross members, and posts. The wooden fence may be assembled into prepackaged panels prior to treatment by the slurry. Other methods permit for the individual coating of each member of the fence with assembly of the fence structure after coating.

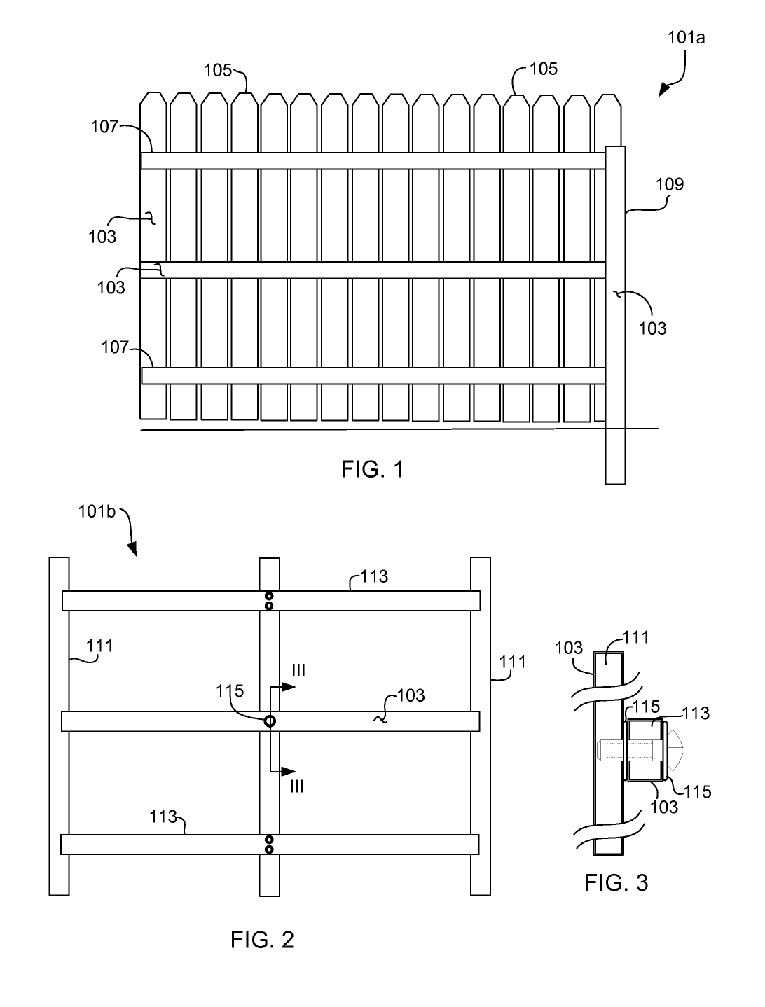

Referring now to FIGS. 1 and 2 in the drawings, exemplary forms of wooden structures are illustrated. Wooden structures 101a and 101 b are each coated with a dried slurry coating 103 according to the steps of the present application. As seen, wooden structures 101a and 101b are fences. In FIG. 1, fence 101a includes a plurality of pickets 105, a cross member 107 and a post 109. A panel includes cross members 107 and the plurality of pickets 105.

The wooden fence structure of FIG. 2 is a different exemplary embodiment of a fence. Fence 101 b includes a series of posts 111 and cross members 113. As stated above, fences 101a and 101b are coated with a dried slurry made from ground up recycled tires. The slurry is applied either prior to assembly or after assembly. For example, each picket 105 may be coated and sold in that form for repair. In another example, a panel may be assembled together and then coated. An object of the present method is the protection of the wooden structure from natural elements, such as weather, water, insects, rot, decay, and deterioration. When the wooden structure is assembled after coating, it is understood that fasteners are designed to penetrate through one or more members for attachment. Therefore in an effort to maintain protection of the wooden structure, insertion of a seal is used at one or more puncture locations of the wood (i.e. at the entrance and/or exit locations of the wood)

Referring now also to FIG. 3 in the drawings, a section view of fence 101b is illustrated to show the use of a seal 115. Seal 115a is shown under the head of screw 117 while a second seal 115b is shown between cross member 107 and picket 105. Second seal 115b protects the exit point for member 107 and the entrance point for picket 105. Seals 115a and 115b are optional to use but ensure a complete seal against the natural elements.

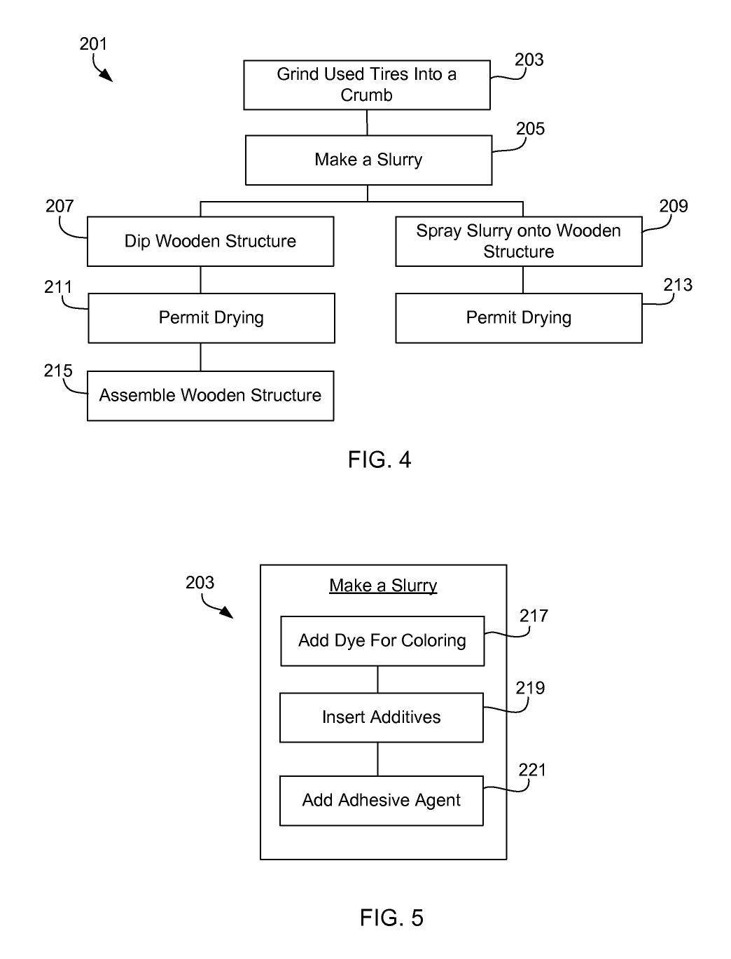

Referring now to FIG. 4 in the drawings, a chart illustrating the process for protecting the wooden structure is shown. Process 201 is provides the steps used to take used tires and create a protective rubberized layer or coating on a fence or wooden structure (i.e. 101a and 101b). One or more tires are collected for recycling. The tires are organized and ground up 203 into a crumb. The appropriate materials are separated out, include the metallic pieces and non-rubberized components. The rubberized crumb is sorted and processes to make a slurry 205. The precise steps of making crumb from tires and converting the remnants into a liquid form is known in the art. The slurry is composed of the crumb and an assortment of other chemicals and additives to permit the flexibility and resistance to cracking necessary to handle the natural elements. Other elements potentially added to the slurry will be discussed in relation to FIG. 5 below. The contents or chemical additives used with the slurry are not necessarily known in the art. This as well as the additional steps of process 201 differentiate the process of the present application from the prior art.

Application of the slurry onto the wooden structure may occur via a number of ways. In particular here, the application of slurry onto the wooden structure is illustrated via a submersion or dipping process 207 or via a spray process 209. With either process 207, 209 elements within the wooden structure may be done individually or collectively. When dipped, the element is submerged until a coating is obtained. The wooden structure is removed from the slurry bath and allowed to drain and eventually dry 211. When sprayed, the wooden structure is propped and supported in a particular orientation and sprayed with a controlled and selected feed rate of slurry. Spraying continues until the entire wooden structure is coated to an ideal thickness. The coating is then allowed to dry 213. It is important to note that the process of the present application only requires one coating or application of slurry. The slurry is configured to hold all the ingredients necessary to provide a durable layer with a single coating. This allows for a simpler and quicker application. Furthermore only one product is used or applied as opposed to multiple products needed and multiple applications.

An advantage of dipping the wooden structure is the ability to infuse or bond the coating with the wooden structure. By varying the time of submersion within the slurry bath, the level of absorption can increase or decrease. An advantage of spraying the wooden structure is the ability to control the thickness level of the coating to a more precise degree as opposed to submersion. Although dipping 207 and spraying 209 have been disclosed, it is understood that other methods of applying the slurry to the wooden structure are also contemplated. For example, situations may arise where the wooden structure needs to be trimmed or cut. In this situation, a brush may be used to apply a slurry coating to the particular area. Wet slurry is configured to bond to and seal against dry slurry.

As noted previously, assembly of wooden structures may be performed prior to or after application of the slurry coating. Assembly of the wooden structure 215 is shown following the drying process 211 but it is understood to be optionally performed at any point prior to or after the application of slurry and the drying process for either application process 207, 209.

Referring now also to FIG. 5 in the drawings, additional optional steps for making slurry 205 are illustrated. Process 201 may further include the addition of dye 217. Dye is used to add a tint or coloring to the end dried slurry coating. Inclusion of dye within the slurry eliminates the need to add an additional step of staining the wooden structure following application of the slurry. Additionally, the slurry as used in the present application is configured to resist fading from UV radiation and the natural elements.

Additives may also be added 219 to the slurry mixture. Coating 103 is configured to resist cracking as a result of exposure to Oxygen (O₂) and Ozone (O₃). The additives are configured to resist oxygen and ozone deterioration. Deterioration from Ozone is typically a rapid reaction process that occurs in rubberized materials. Evidence is seen in cracking or surface frosting. Antiozonants are added to the slurry to combat the effects of Ozone. Examples of antiozonants are UOP 88, UOP 288, UOP 788, and UOP 588. Other antiozonants are contemplated. These antiozonants are preferably added prior to the vulcanization process involved in making the slurry.

Deterioration from Oxygen differs from that of Ozone. Oxygen attacks rubberized materials rather slowly compared to Ozone. This results in a slow softening or hardening as evidenced in cracking along the areas of stress. Antioxidants are added to the slurry as additives to counter the effects of Oxygen. Examples of antioxidants are: diphenylamine-acetone reaction products with Amine materials being effective also. It is understood that other types of additives may also be added during the slurry making process. Additives may be used to add flexibility, consistency, and stability to the mixture. Additionally, additives may further be used to make handling of the slurry more environmentally safe.

An adhesive agent may also be added to the slurry 221. The adhesive agent is configured to assist in the bonding between the slurry itself and the wooden structure. This is particularly designed to be useful in assisting in the bonding of the slurry to itself after the drying process. This permits repairs or modifications to be possible.

Process 201 and the associated slurry and resultant coating 103 are configured to provide a purpose to worn and used discarded tires that pollute the earth either in landfills or in the air as bi-products of being burned for fuel. The slurry coating is configured to be applied to all sides of the wooden structure with the idea to seal the internal wooden structure from the natural elements. The coating is UV resistant so as to avoid cracking over time. The additions of additives help preserve the coating and the wooden structure from deterioration. Because the wooden structure is completely sealed by the coating, it is preferred that the wooden structure be dried and not contain a lot of moisture which will need to expand. If necessary, step 201 may further include the step of pre-drying the wooden structure before coating with slurry.

The current application has many advantages over the prior art including at least the following: (1) a process involving the coating of a wooden structure with a weather resistant coating in a single application step; (2) reduced number of chemicals to buy to apply the slurry; (3) multiple application methods available; (4) insertion of a dye within the slurry to avoid the step of staining the wooden structure following application of the slurry; and (5) use of adding a seal with the fasteners to protect entry and exit locations in the wooden structure from the penetration of fasteners.

The particular steps and embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method for protecting a wooden structure, comprising:
grinding used tires into a crumb;
making a slurry from the crumb;
coating the wooden structure with the slurry; and
permitting the coating of slurry to dry;
wherein dry coating of slurry is configured to protect the wooden structure from natural elements.

2. The method of claim 1, wherein the coating is applied in a single application of slurry.

3. The method of claim 1, wherein the step of making the slurry further comprises:
adding a dye agent to obtain a selected coloring.

4. The method of claim 1, wherein the step of making the slurry further comprises:
adding an additive configured to resist oxygen and ozone deterioration.

5. The method of claim 1, wherein the step of making the slurry further comprises:
adding an adhesive agent configured to promote the bonding of the dried slurry to the wooden structure.

6. The method of claim 1, wherein the step of coating the wooden structure is performed by dipping a portion of the wooden structure in the slurry.

7. The method of claim 6, further comprising:
assembling the wooden structure.

8. The method of claim 7, wherein the act of assembling the wooden structure occurs prior to coating the wooden structure with the slurry.

9. The method of claim 1, wherein the step of coating the wooden structure is performed by spraying the slurry on the wooden structure.

10. The method of claim 9, wherein the wooden structure is assembled prior to spraying the slurry coating.

11. The method of claim 9, wherein the wooden structure is a combination of individually coated wooden structures.

12. The method of claim 11, wherein assembly of the coated wooden structure further includes:
locating one or more seals between a fastener and the coated wooden structure so as to prevent exposure to the natural elements.

13. The method of claim 1, wherein the slurry includes additives configured to resist deterioration from oxygen and ozone, the slurry including at least one of antioxidants and antiozonants.

14. The method of claim 1, wherein the slurry is applied via a brush.

15. A method for protecting a wooden structure, comprising:
grinding used tires into a crumb;
making a slurry from the crumb;
coating the wooden structure with the slurry, the slurry being applied to the wooden structure via a spray; and
permitting the coating of slurry to dry;
wherein dry coating of slurry is configured to protect the wooden structure from natural elements.

16. A method for protecting a wooden structure, comprising:
grinding used tires into a crumb;
making a slurry from the crumb;
coating the wooden structure with the slurry, the coating being applied to every surface of the wooden structure, the coating configured to form a seal around the wooden structure; and
permitting the coating of slurry to dry;
wherein dry coating of slurry is configured to protect the wooden structure from natural elements.
